(19) United States
(12) Patent Application Publication
(10) Pub. No.: US 2013/0254333 A1
(43) Pub. Date: Sep. 26, 2013

(54) REDIRECTION CONTENT REQUESTS

(71) Applicant: FORTINET, INC., Sunnyvale, CA (US)

(72) Inventor: Barrett Gibson Lyon, Pacifica, CA (US)

(21) Appl. No.: 13/849,525

(22) Filed: Mar. 24, 2013

Related U.S. Application Data
(62) Division of application No. 13/020,762, filed on Feb. 3, 2011.
Application No. 13/020,762 is a continuation-in-part of application No. 12/655,900, filed on Jan. 7, 2010, now abandoned.
(60) Provisional application No. 61/269,646, filed on Jun. 25, 2009.

(51) Int. Cl. H04L 12/26

(52) U.S. Cl. CPC H04L 43/0876
USPC 709/217

(57) ABSTRACT

Methods and systems for redirecting content requests are provided. According to one embodiment, a content request is received at a redirect host that communicates via a public network. The redirect host determines that the content request is received from an internal client of a private network. The redirect host determines that an internal server within the private network is available to service the request. The redirect host redirects the client or request to the internal server of the private network.

### CROSS-REFERENCE TO RELATED APPLICATIONS

This application is a divisional of U.S. patent application Ser. No. 13/020,762, filed Feb. 3, 2011, which is a continuation-in-part U.S. patent application Ser. No. 12/655,900, filed Jan. 7, 2010, which claims priority to U.S. Provisional Application No. 61/269,646, filed Jun. 25, 2009, all of which are hereby incorporated by reference in their entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2009-2013, Fortinet, Inc.

### BACKGROUND

1. Field

Embodiments of the present invention generally relate to handling of content requests. In particular, embodiments of the present invention relate to intelligent redirection of content requests.

2. Description of the Related Art

Typically, requests for content published by a publisher are indiscriminately directed or redirected to content delivery network servers capable of servicing the requests. It would be useful to more intelligently redirect content requests.

### SUMMARY

Methods and systems are described for redirecting content requests. According to one embodiment, a content request is received at a redirect host that communicates via a public network. The redirect host determines that the content request is received from an internal client of a private network. The redirect host determines that an internal server within the private network is available to service the request. The redirect host redirects the client or request to the internal server of the private network.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating a network environment for operating a crowd based computing platform in accordance with an embodiment of the present invention.

FIGS. 2A-2B illustrate processes for adding a resource provider to a network managed by a resource manager in accordance with various embodiments of the present invention.

FIGS. 3A-3B illustrate processes for employing a resource provider configured as a proxy server to service a content request in accordance with various embodiments of the present invention.

FIGS. 4A-4B illustrate processes for adding a resource consumer to the network managed by the resource manager in accordance with various embodiments of the present invention.

FIG. 5A is a block diagram illustrating a resource manager in accordance with an embodiment of the present invention.

FIG. 5B illustrates a process for redirecting a request for a content item to a resource provider in accordance with an embodiment of the present invention.

FIGS. 6A-6C are block diagrams illustrating manners in which a content request from an end user is redirected by the resource manager to a node capable of servicing the request in accordance with various embodiments of the present invention.

FIG. 7A is a block diagram illustrating a network environment for redirecting clients and/or client requests to an appropriate endpoint in accordance with an embodiment of the present invention.

FIG. 7B is a block diagram illustrating a network environment in which a publisher network comprises private networks in a plurality of geographical locations in accordance with an embodiment of the present invention.

FIG. 7C is a block diagram illustrating communications involved in servicing a content request in accordance with an embodiment of the present invention.

FIG. 7D comprises flow charts illustrating corresponding processes of the communications of FIG. 7C in accordance with various embodiments of the present invention.

FIG. 7E is a block diagram illustrating communications involved in servicing a content request in accordance with an embodiment of the present invention.

FIG. 7F comprises flow charts illustrating corresponding processes of the communications of FIG. 7E in accordance with various embodiments of the present invention.

FIG. 8 illustrates a process for selecting an appropriate endpoint for servicing a client request in accordance with an embodiment of the present invention.

### DETAILED DESCRIPTION

Methods and systems are described for redirecting content requests. Embodiments of the present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims, and the invention encompasses numerous alternatives, modifications and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

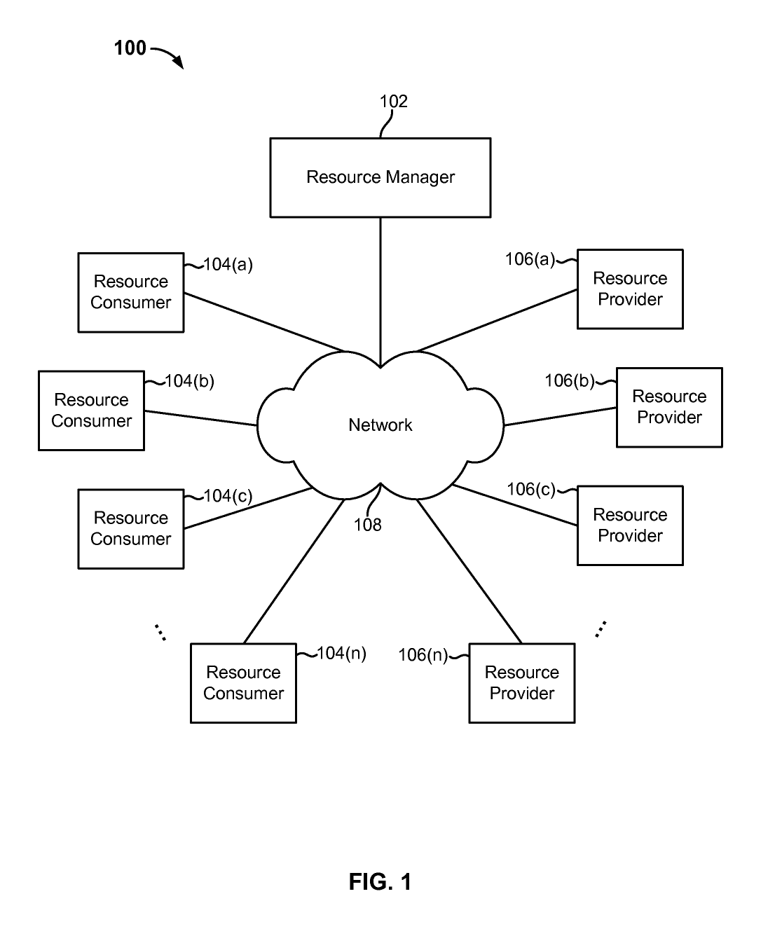

FIG. 1 is a block diagram illustrating a network environment 100 for operating a crowd based computing platform in accordance with an embodiment of the present invention. Resource manager or aggregator 102 facilitates transactions between resource consumers 104 and resource providers 106. The various entities comprising network environment 100 communicate via network 108, which may comprise any public or private network such as a LAN, WAN, the Internet, etc., using any appropriate communication protocol such as HTTP (Hypertext Transfer Protocol), SSL (Secure Sockets Layer), RTMP (Real Time Messaging Protocol), RTMP-E (Encrypted Real Time Messaging Protocol), RTMP over HTTP, torrent style protocols, etc. Resource manager 102 manages anyone or more types of computing resources for performing tasks such as, but not limited to, content distribution or delivery, parallel processing, security, storage, etc. Although depicted as a single entity in network environment 100, resource manager 102 may comprise a plurality of interconnected computing systems that perform the various tasks associated with managing resources. Resource providers 106 comprise a crowd of members who donate or sell their resources to resource consumers 104. Any type of member may be a part of the crowd of resource providers 106 such as individuals, groups, corporations, universities, content delivery networks (CDNs), internet service providers (ISPs), carriers, cloud computing networks, server farms, etc. Resource manager 102 handles various processes associated with the exchange of resources between resource providers 106 and resource consumers 104 such as monitoring performance, tracking statistics, enforcing provider and consumer preferences, providing security, billing, etc. Although a single resource manager 102 is depicted in network environment 100, a plurality of networked resource managers may be deployed across various geographical regions, e.g., to manage resource providers and resource consumers across the world.

As further described herein, the resource manager establishes and manages a confederation of resource providers. A resource provider may comprise any network node that has extra capacity that can be provided or sold to consumers who need the resource. A resource provider, for example, may set a price for an available resource, and if a consumer finds that resource attractive, the consumer pays for the right to use it. In some embodiments, the resource manager assists a resource provider in becoming a CDN or CDN node that is capable of delivering content on behalf of a content publisher, i.e., the resource consumer in this case. In some such cases, for example, the resource manager provides configuration software which when installed on one or more servers of the resource provider configures the servers to behave as CDN nodes. A resource provider configured as a CDN node may be employed to serve content based on the availability of resources at the node, which may vary based on factors such as current load, day and time, geographic location, etc.

Although many of the given examples are with respect to crowd based content delivery, the techniques described herein may be employed with respect to any computing resource and/or task. The described techniques allow excess capacity of resource providers that is otherwise unused and wasted to be utilized and/or monetized. For example, even though many ISP and carrier networks are bidirectional (e.g., a 10 Gigabit connection comprises 10 Gigabit inbound and 10 Gigabit outbound), they typically have significantly more inbound traffic due to users downloading content than outbound traffic due to relatively fewer users uploading content, resulting in a large amount of unused outbound bandwidth. These networks typically only pay for one direction of traffic, either ingress or egress, whichever is greater. Since inbound traffic usually eclipses outbound traffic, the networks commonly have a large amount of free idle outbound bandwidth. It would be useful, for example, to add servers at these networks and configure them as CDN nodes so that the extra available outbound bandwidth can be utilized and/or monetized using the techniques described herein.

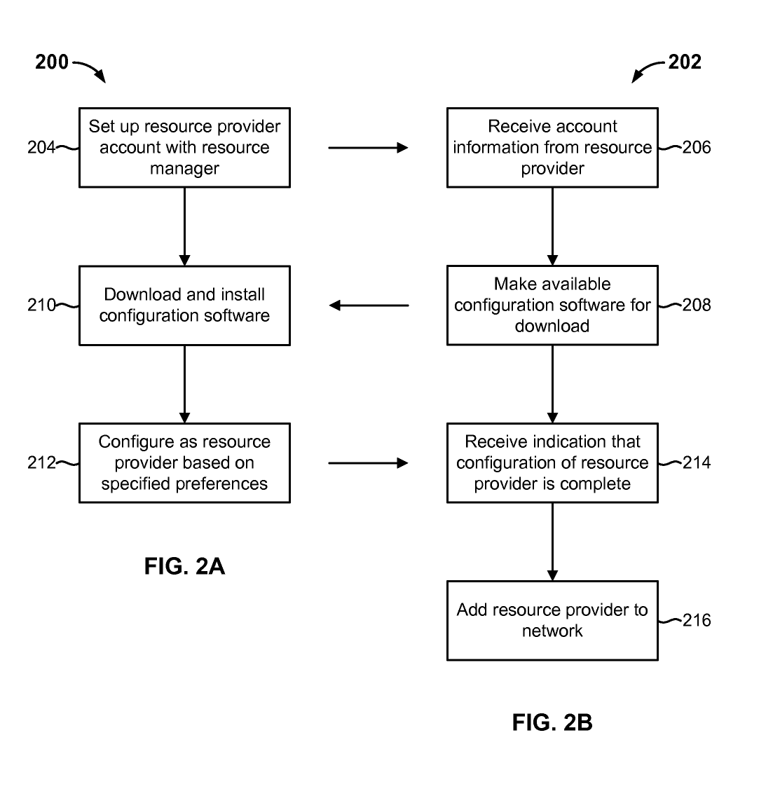

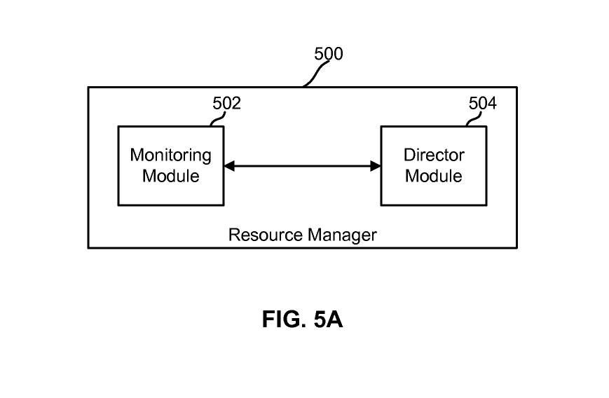

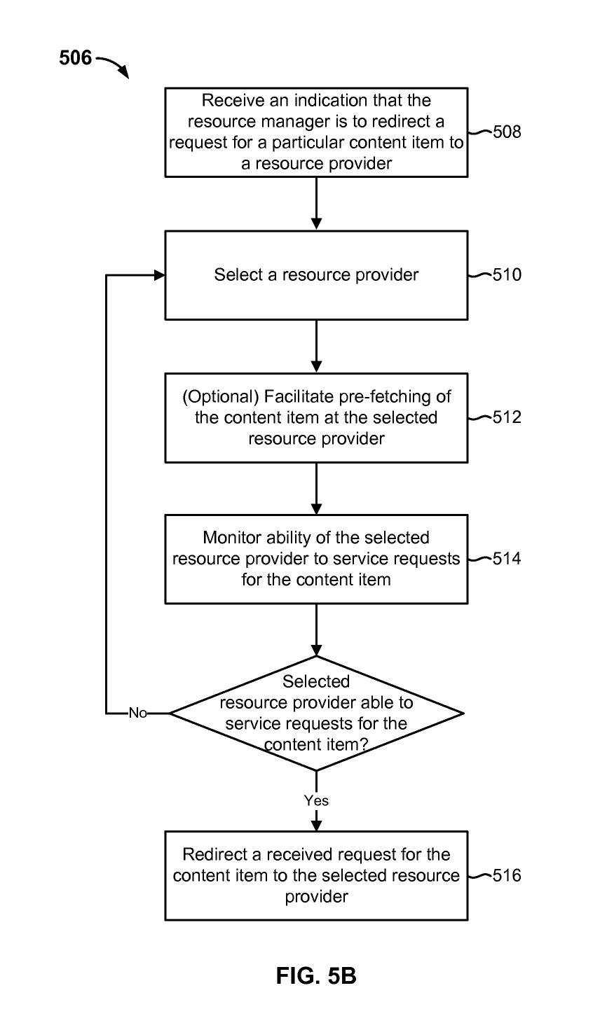

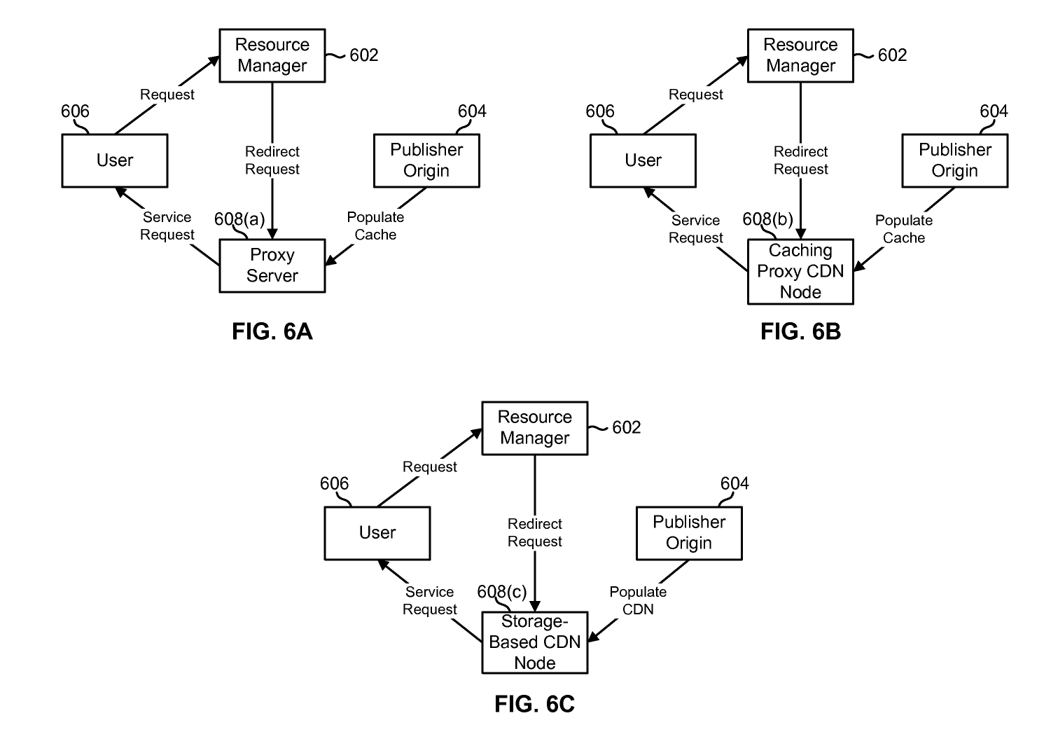

FIGS. 2A-2B illustrate processes for adding a resource provider to a network managed by a resource manager in accordance with various embodiments of the present invention. In some cases, the processes may be employed to configure a network node to become a CDN node capable of delivering content on behalf of a content publisher. Process 200 is employed by a resource provider such as any of resource providers 106 of FIG. 1 or resource provider 608(a) of FIG. 6A; and process 202 is employed by a resource manager such as resource manager 102 of FIG. 1, resource manager 500 of FIG. 5A, or resource manager 602 of FIGS. 6A-6C. Process 200 starts at 204 at which a resource provider sets up an account with the resource manager, e.g., via a web site and/or interface made available by the resource manager. Various parameters that define the terms and conditions with respect to which the resource provider is willing to provide resources or services are specified with respect to the resource provider's account. For example, the types of resources and/or the services that the resource provider is willing to deliver and/or perform may be specified. In the cases in which it is desired to configure the resource provider as a CDN node, for instance, a proxy server option is selected. The specification of resources may further include a specification of the amount or percentage of a total resource (e.g., hard drive, memory, CPU, network bandwidth, etc.) to be made available, which may be specified as a function of time. Moreover, resource consumers and/or types of resource consumers may be specified, e.g., on an inclusion or exclusion basis. The various entities permitted to use and/or excluded from using the resource provider's resources may be specified or selected by name and/or by the nature of their business. For example, in some cases, any nonprofit organization may be permitted to use the resource provider's resources while in other cases only one or more specified entities may be permitted. Similarly, content types for using the resources or services with may be specified, e.g., on an inclusion or exclusion basis. For example, in some cases, any content type other than adult content may be specified as permissible.

Furthermore, prices at which the resource provider is willing to provide resources or services may be specified. Different prices may be specified based on different criteria such as consumer or consumer type, content type, time of use, etc. For instance, resources may be donated or provided for free to nonprofit organizations but charged a specified price per unit from other consumers and different prices may be specified for different consumers; higher prices may be specified for use of resources with respect to certain types of content such as adult content; prices may be specified as functions of time and/or date, e.g., higher prices may be specified during business hours when the resource provider has peak loads than during nights, weekends, and holidays; etc. Other information such as the geographic location of the resources, environmental considerations such as the carbon footprint for providing a resource or service, etc., may also be specified. The various parameters described may be separately specified for each machine or server available at the resource provider. The account information provided at 204 is received by the resource manager at 206 of process 202. In some embodiments, steps 204 and 206 include the resource provider acquiring and being granted by the resource manager a resource provider identifier and key or password via which the resource provider's account with the resource manager may be accessed. In various embodiments, the parameters and information described above as being specified with respect to a resource provider's account may be specified during initial registration or at a later time and may be later updated or changed as applicable. Other parameters in addition to and/or instead of those described may be specified as applicable.

Software for configuring a node as a resource provider made available by the resource manager at 208 is downloaded and installed by the resource provider at 210. In various embodiments, the software may comprise an application, an operating system, a server instance such as a Java Virtual Machine, a specialized C proxy application such as Varnish that runs on a server, a plug-in for a browser or any other application or interface, etc. One or more parameters or preferences specified with respect to the resource provider's account with the resource manager may be retrieved during installation of the software at 210. In some embodiments, one or more parameters or preferences may be specified during installation at 210 rather than during step 204 as described above. The configuration software is installed at 210 on each computer or machine desired to be configured as a resource provider. At 212, the software installed on a machine appropriately configures the machine as a resource provider based on the preferences specified. For example, a machine may be configured by the software at 212 to function as a caching proxy server. In some embodiments, the software conducts one or more performance tests at 212 to assess the quality of the available resources. For example, performance tests on the hard drive, memory, CPU, network connections, etc., may be performed. Once a node has been configured as a resource provider at 212, an indication that the configuration is complete is communicated by the software and received by the resource manager at 214. In some embodiments, the resource manager receives at 214 the results of the performance tests conducted at 212. The results of the performance tests are reported to the resource manager so that the resource manager can appropriately market and provide or sell the resources to resource consumers. In some embodiments, performance tests are periodically conducted by the software at the resource provider and reported back to the resource manager so that the resource manager is always aware of changes in performance levels and can make appropriate use of the resources of the resource provider. At 216, the resource provider is added to the network managed by the resource manager.

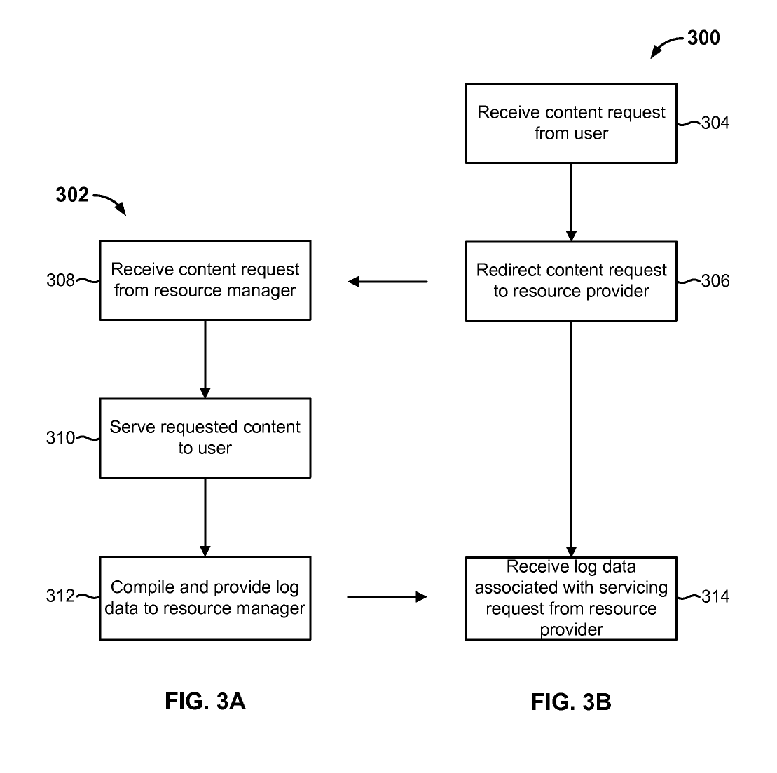

FIGS. 3A-3B illustrate processes for employing a resource provider configured as a proxy server to service a content request in accordance with various embodiments of the present invention. Process 300 is employed by a resource manager such as resource manager 102 of FIG. 1, resource manager 500 of FIG. 5A, or resource manager 602 of FIGS. 6A-6C; and process 302 is employed by a resource provider such as any of resource providers 106 of FIG. 1 or resource provider 608(a) of FIG. 6A. Process 300 starts at 304 at which a content request is received by the resource manager from a user. The requested content, for example, is published by a content publisher that uses content delivery resources and is the resource consumer in this case. In this example, the content publisher subscribes to the services of the resource manager for facilitating the servicing of requests for content published by the content publisher, and the requests for the publisher's content from individual users are directed or redirected to the resource manager. At 306, the content request received at 304 is redirected by the resource manager, e.g., via an HTTP 302 redirect (or similar content redirect action in other protocols such as RTMP), to a resource provider capable of servicing the request and permitted by the resource consumer to service the request. The redirected content request is received by the resource provider at 308, and the requested content is served by the resource provider to the user who requested the content at 310. In some embodiments, the requested content is already cached at the resource provider when it receives the request at 308. In other embodiments, the resource provider obtains and caches the requested content from an origin of the content publisher in response to receiving the request at 308. Log data of the transaction, which includes information associated with delivering the requested content (such as the file identifier, timestamp of delivery, the source and/or destination IP addresses, the file size, the bandwidth consumed, the price or cost for delivery, etc.), is compiled by the software at the resource provider and communicated to the resource manager at 312. In some embodiments, the log data at least in part comprises a W3C web server log. The log data is received by the resource manager at 314. In some embodiments, the log data received at 314 is parsed, aggregated, and/or stored at the resource manager and may, for example, be later employed for billing the associated resource consumer and reimbursing the resource provider.

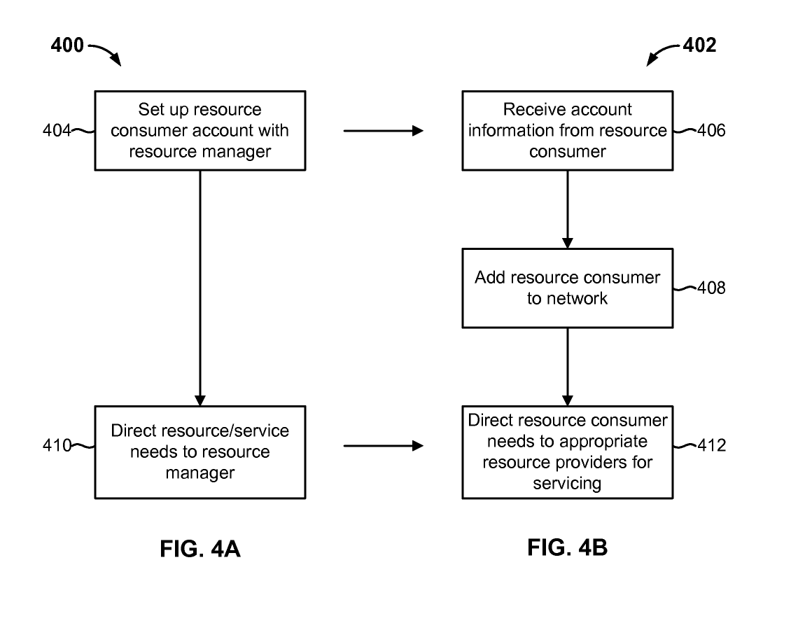

FIGS. 4A-4B illustrate processes for adding a resource consumer to the network managed by the resource manager in accordance with various embodiments of the present invention. Process 400 is employed by a resource consumer such as any of resource consumers 104 of FIG. 1; and process 402 is employed by a resource manager such as resource manager 102 of FIG. 1, resource manager 500 of FIG. 5A, or resource manager 602 of FIGS. 6A-6C. Process 400 starts at 404 at which a resource consumer sets up an account with the resource manager, e.g., via a web site and/or interface made available by the resource manager. Various parameters that define the terms and conditions with respect to which the resource consumer is willing to use or purchase resources or services are specified with respect to the resource consumer's account. For example, the types of resources and/or services that the resource consumer desires to use or purchase as well as the types of content with respect to which the resource consumer expects to use the resources and services may be specified. For instance, the resource consumer may sign up for content delivery services for serving video content. Furthermore, other criteria such as the required quality or performance levels, the required security levels, etc., may be specified. In addition, resource providers and/or resource provider types may be specified, e.g., on an inclusion or exclusion basis. The various entities permitted to provide and/or excluded from providing resources or services to the resource consumer may be specified or selected by name and/or by type. For example, a content publisher seeking content delivery services may not allow untrusted members of the crowd such as random individual users to serve their content but may allow trusted entities, such as prominent ISPs or carriers, to serve their content. Moreover, prices or price ranges that the resource consumer is willing to pay for various resources and services may be specified. Different prices may be specified based on different criteria such as resource provider or provider type, content type, time of use, etc. Other information such as geographic location, environmental considerations such as the permissible carbon footprint for obtaining a resource or service, etc., may also be specified. The various parameters described may be separately specified for each resource or service or type of resource or service desired by the resource consumer.

The account information provided at 404 is received by the resource manager at 406 of process 402. In some embodiments, steps 404 and 406 include the resource consumer acquiring and being granted by the resource manager a resource consumer identifier and key or password via which the resource consumer's account with the resource manager may be accessed. In various embodiments, the parameters and information described above as being specified with respect to a resource consumer's account may be specified by the resource consumer during initial registration or at a later time and may be later updated or changed as applicable. Other parameters in addition to and/or instead of those described may be specified by the resource consumer as applicable. With respect to a content publisher signing up for content delivery services, for example, content origin locations where the content is published may be specified; and/or CDN providers with which the content publisher has contracts, if any, and the terms of those contracts may be specified so that those CDN providers may be used to service content requests. The resource consumer is added to the network managed by the resource manager at 408. Once the resource consumer subscribes with the resource manager for a particular resource and/or service, needs for that resource and/or service are directed by the resource consumer to the resource manager at 410. With respect to content delivery, for example, when a content publisher subscribes to the services of the resource manager for servicing content requests, the content publisher ensures that user requests for content published by the content publisher are directed or redirected to the resource manager. Resource consumer needs are, in turn, directed for servicing to appropriate resource providers in the network by the resource manager at 412 based on the preferences specified by the resource consumer. In some embodiments, a network node may sign up both as a resource provider and a resource consumer for the same or different resources, e.g., using process 200 and 202 of FIGS. 2A-2B and processes 400 and 402 of FIGS. 4A-4B.

The resource manager comprises one or more networked modules, each of which may comprise one or more hardware and/or software components. FIG. 5A is a block diagram illustrating a resource manager 500 in accordance with an embodiment of the present invention. For example, resource manager 500 may comprise resource manager 102 of FIG. 1 or resource manager 602 of FIGS. 6A-6C. In the depicted embodiment, resource manager 500 comprises a monitoring module 502 and a director module 504. Monitoring module 502 monitors the health of the network and various nodes. Data may be received by or input into monitoring module 502 from a variety of sources, e.g., on the Internet. Different types of data may be input by different sources depending on the types of data available to them. In some embodiments, the data comprises performance statistics associated with quality of service and end user experience such as average and/or maximum throughput, DNS lookup time, time to first connection, download time, etc. In some cases, dedicated monitoring servers may be placed across the network that report back various performance characteristics. In some cases, log data compiled by resource providers at the conclusion of each transaction and/or logs of open proxy servers may be input into monitoring module 502. In some cases, plug-ins may be included in sources such as web browsers, media players, download agents, etc., that ping back the performance statistics available to them. The data received by monitoring module 502 is parsed, analyzed, aggregated, and/or stored. In some embodiments, various entities may desire to obtain and/or purchase performance statistics on their nodes and/or networks. In such cases, the relevant data compiled by monitoring module 502 may be presented or reported, e.g., via a dashboard, to the entity, i.e., the resource consumer in this case. For example, a CDN may be interested in monitoring the health of its nodes so that a prescribed quality of service can be maintained, and a server farm may find a real time dashboard providing statistics on inbound and outbound traffic useful.

Director module 504 receives requests for resources or services and selects appropriate resource providers to service the requests based on the preferences specified by the resource consumers and resource providers. In some embodiments, decisions for selecting resource providers are made by director module 504 based at least in part on the data collected and/or information learned by monitoring module 502. With respect to content delivery, for example, if a portion of a CDN in a particular geographical region goes down, existence of the black spot (i.e., a poorly performing area in a network or geography) in the CDN is quickly learned by monitoring module 502 and communicated to director module 504 so that content requests are not redirected by director module 504 to at least those nodes of the CDN. A prescribed quality of service and user experience is maintained in the network managed by traffic manager 500 by making decisions based on the current state of the network and its constituent nodes as determined by monitoring module 502. In some embodiments, monitoring module 502 includes a spider process that monitors the requests coming into resource manager 500 and that crawls the network managed by resource manager 500 to determine and/or report the availability of various resource providers to service incoming requests. With respect to content delivery, for example, the spider learns and stores the locations of content items (i.e., files) in the network. For instance, the spider may interrogate a CDN using an appropriate interrogation methodology (e.g., an HTTP HEAD request or similar request in RTMP or other protocols) to determine the availability of a particular content item at the CDN. The spider may also coordinate pre-fetching of a content item at a node to warm the cache at the node before a request for that content item is redirected to the node by director module 504. Thus, the spider assists director module 504 in directing a request to a resource provider capable of servicing the request. In some embodiments, decisions for selecting resource providers are made by director module 504 based at least in part on past traffic redirected to the resource providers, e.g., to prevent any given resource provider from becoming overloaded and/or to load balance a plurality of available resource providers. In some embodiments, information associated with the requests redirected by director module 504 (such as the resource requested, the user and/or resource consumer issuing the request, the resource provider selected to service the request, the type and amount of resources expected to service the request, the resource provider price for servicing the request, etc.) may be logged and stored at the resource manager and later employed, e.g., to generate statistics or for billing purposes.

FIG. 5B illustrates a process for redirecting a request for a content item to a resource provider in accordance with an embodiment of the present invention. Process 506 is employed by a resource manager such as resource manager 102 of FIG. 1, resource manager 500 of FIG. 5A, or resource manager 602 of FIGS. 6A-6C. In various embodiments, process 506 may be employed in anticipation of receiving a request for a content item or in response to receiving a request for a content item. Process 506 starts at 508 at which an indication that the resource manager is to redirect a request for a particular content item to a resource provider capable of servicing the request is received. In some embodiments, the indication is received from the publisher of the content item, i.e., the resource consumer in this case, such as via the publisher's account with the resource manager or via learning from the publisher origin the content published by the publisher. In some embodiments, the indication is received in response to a (previous) request for that content item being forwarded or redirected to and/or received by the resource manager. At 510, an appropriate resource provider capable of servicing requests for the content item is selected, e.g., based on the preferences specified by the content publisher. In some embodiments, the selected resource provider comprises a network node configured as a proxy server, e.g., via process 200 of FIG. 2A. In some embodiments, the selected resource provider comprises a CDN. In some such cases, the content publisher may have specified using the CDN to service requests, e.g., based on the terms of an existing contract with the CDN. In some embodiments, a resource provider able to service requests for the content item at a least cost to the publisher but at the required security and/or quality level is selected at 510. At 512, the resource manager may optionally facilitate pre-fetching of the content item at the selected resource provider to warm the cache at the resource provider. The ability of the selected resource provider to service requests for the content item in accordance with the preferences specified by the content publisher is monitored at 514, e.g., by a spider process of monitoring module 502 of FIG. 5A. In some embodiments, the availability of the content item at the selected resource provider is also monitored at 514; and if the content item is at some point determined to be unavailable, in some cases process 506 may be redirected to step 512 (not shown in FIG. 5B). A received request for the content item is redirected, e.g., by director module 504 of FIG. 5A, to the selected resource provider at 516 in the event that the selected resource provider is able to service the request. In the event that the selected resource provider is unable to service a received request for the content item, a different resource provider capable of servicing the request is selected at 510.

FIGS. 6A-6C are block diagrams illustrating manners in which a content request from an end user is redirected by the resource manager to a node capable of servicing the request in accordance with various embodiments of the present invention. In the network environments depicted in the examples of FIGS. 6A-6C, the resource consumer comprises a content publisher that has subscribed to the services of the resource manager for servicing user requests for content published by the content publisher. When signing up for the services of resource manager 602 (e.g., at 404 of process 400 of FIG. 4A), the content publisher specifies the locations of one or more associated publisher origins 604 from which content published by the content publisher can be obtained and cached at other nodes. A request from user 606 for content (e.g., a file) published by the publisher is directed or redirected to resource manager 602. For example, the request may comprise a hyperlink or URL that redirects to resource manager 602. Resource manager 602 selects an appropriate node 608 to service the request based on the preferences specified by the content publisher and redirects the request to node 608. In various embodiments, the requested content may be obtained by node 608 from publisher origin 604 (or from another node at which the content is available) either prior to receiving the redirected request or in response to receiving the redirected request. Node 608 provides the requested content to user 606, fulfilling servicing of the original request. In some embodiments, the various redirections of the original request are transparent to the user. In some embodiments, a set of one or more initial requests for a content item may be redirected by resource manager 602 to publisher origin 604 and serviced by publisher origin 604 (not shown in FIGS. 6A-6C), e.g., when the requested content item has not yet been populated at other nodes 608 or when the existence of the requested content item at various other nodes 608 is unknown to resource manager 602.

In the example of FIG. 6A, the request is redirected by resource manager 602 to a node 608(a) configured (e.g., via process 200 of FIG. 2A) to at least in part function as a proxy server. Proxy server 608(a) comprises a confederated node of the network managed by resource manager 602 since it has willingly signed up to be a part of the network. In some embodiments, a spider process of the monitoring module of resource manager 602 coordinates pre-fetching of a content item at the proxy server cache before any request for that content item is redirected to proxy server 608(a) so that the request is redirected to a warm cache. Alternatively, proxy server 608(a) may obtain and cache the requested content item in response to receiving a first request for the content item or a first request for the content item after a previous copy of the content item has been purged from its cache. A cached copy of the content item at proxy server 608(a) is deleted from the cache at the expiration time associated with the cached copy, and a new copy of the content item may subsequently be obtained to refresh the cache. A transaction log for servicing the request is compiled at proxy server 608(a) and provided to resource manager 602, e.g., so that it can be used by resource manager 602 to bill the content publisher and reimburse the provider of proxy server 608(a).

The content publisher may require security between the proxy server cache and the publisher origin. In some embodiments, content is both transacted from the publisher origin securely and locally cached securely using an encryption algorithm to prevent spreading of the content to nodes configured to serve it and to ensure integrity of the caches at the nodes. In some embodiments, the software installed on a node to configure it as a proxy server includes a built in shared secret that is employed to encrypt files that are stored in the local cache, to access the remote origin, and to sign transaction logs. Such a security system may also include an autoupdate mechanism to update the shared secret along with monitoring to disable nodes that attempt to tamper with the log signatures. The transaction logs are signed using the shared secret. Each chunklet of log data sent back to the resource manager includes a timestamp and a hash of the entire log chunklet, which includes the shared secret. When the resource manager receives the log chunklet, it verifies the data by performing the same hash and compares the received hash with its locally generated hash.

In the example of FIG. 6B, the request is redirected by resource manager 602 to a node 608(b) of a caching proxy CDN. In this example, the content publisher has a pre-existing contract with the caching proxy CDN and thus requires at least a portion or a specified amount or percentage of its traffic to be serviced by this CDN. The terms of the content publisher's contract with the CDN may be specified, for example, with respect to its account with resource manager 602 (e.g., at 404 of process 400 of FIG. 4A). As previously described, a spider process of the resource manager may coordinate ensuring that a content item is available at a node before any request for that content item is redirected to that node so that the request is redirected to a warm cache. With respect to the example of FIG. 6B, the availability of the requested content item at CDN node 608(b) may be determined via an HTTP HEAD or other appropriate request to CDN node 608(b). If the content item does not already exist at the CDN node 608(b), in some cases, the spider may independently request the content item from CDN node 608(b) to warm the cache at the node prior to any actual user requests for the content item being redirected to the node. The spider may need to periodically re-learn the availability of the content item at the CDN node, e.g., since the content item may be deleted from the cache at the CDN node if it has not been recently served by the CDN node or at its expiry time. Alternatively, CDN node 608(b) may obtain and cache the requested content item in response to receiving a first request for the content item or a first request for the content item after a previous copy of the content item has been purged from its cache. CDN node 608(b) comprises a federated node of the network managed by resource manager 602 since the caching proxy CDN has been forced to become a part of the network managed by resource manager 602 due to its contract with the content publisher. Since CDN node 608(b) does not comprise a resource provider node established by resource manager 602, no log data is compiled and provided to resource manager 602 for servicing the request, and the CDN independently bills the content publisher for servicing the request. In some embodiments, the caching proxy CDN may choose to join the confederation of resource providers managed by the resource manager, e.g., via process 200 of FIG. 2A.

In the example of FIG. 6C, the request is redirected by resource manager 602 to a node 608(c) of a storage-based CDN. In this example, the content publisher has a pre-existing contract with the storage-based CDN and thus requires at least a portion or a specified amount or percentage of its traffic to be serviced by this CDN. The terms of the content publisher's contract with the CDN may be specified, for example, with respect to its account with resource manager 602 (e.g., at 404 of process 400 of FIG. 4A). The storage-based CDN may only store a subset of the content published by the content publisher. In some cases, the CDN may only store the most popular content published by the content publisher. With respect to a storage based CDN, it is important for the resource manager to verify the availability of a content item at the CDN prior to redirecting any requests for that content item to the CDN because if the CDN does not have the requested content item a content not found error message (such as an HTTP 404 error message) is transmitted to the user who issued the request, with the resource manager remaining unaware that the request was not serviced. The availability of a content item at the CDN may, for example, be determined by a spider process of the resource manager via an HTTP HEAD or other appropriate request. The spider may need to periodically re-learn the availability of the content item, e.g., since the content item may be deleted from the CDN at its expiry time, which is learned by the spider from the HEAD request and stored at the resource manager. In some embodiments, the content publisher is instructed to not remove or delete a content item from the CDN prior to the expiry time of the content item and/or is instructed to notify the resource manager of any such action prior to expiry time so that the resource manager can ensure that a content request is only redirected to the CDN if it has the content item without having to interrogate the CDN for availability of the content item prior to redirecting every request for the content item. With respect to the example of FIG. 6C, the request is redirected to CDN node 608(c) because the requested content item is known by resource manager 602 to be available at CDN node 608(c). CDN node 608(c) comprises a federated node of the network managed by resource manager 602 since the storage-based CDN has been forced to become a part of the network managed by resource manager 602 due to its contract with the content publisher. Since CDN node 608(c) does not comprise a resource provider node established by resource manager 602, no log data is compiled and provided to resource manager 602 for servicing the request, and the CDN independently bills the content publisher for servicing the request. In some embodiments, the storage-based CDN may choose to join the confederation or resource providers managed by the resource manager, e.g., via process 200 of FIG. 2A. By installing the configuration software provided by the resource manager, the nodes of a storage-based CDN may be configured to behave as proxy servers, allowing the storage-based CDN to additionally operate as a caching proxy CDN.

As described in the examples of FIGS. 6B-6C, the resource manager may redirect traffic to a CDN based on the preferences and usage instructions specified by the content publisher. In some embodiments, the resource manager manages publisher contracts with a plurality of different CDNs and redirects publisher traffic based on the terms of the contracts, e.g., in a manner that minimizes content delivery costs to the publisher. For example, the resource manager may minimize or at least reduce a publisher's content delivery costs by intelligently using the bandwidth of one or more contracted CDNs that bill with the 95^{th} percentile billing model. With CDNs that use such burstable billing models, the resource manager may also maximize use of free burstable bandwidth, which on a monthly billing cycle translates to up to 36 hours of free bandwidth per CDN.

In various embodiments, any appropriate billing and settlement model may be employed in the system of resource consumers and resource providers managed by the resource manager. The resource manager keeps track of the participants involved in each transaction as well as details of the transaction, e.g., via the log data received at the conclusion of each transaction from the resource provider. During a (e.g., monthly) settlement process, payments are received from resource consumers and distributed to resource providers as applicable. The resource manager may take a small transaction fee or a small percentage of the payment for facilitating the transaction. In some cases, the resource manager may track and bill for the total number of managed requests. In addition, the resource manager may bill for special services, such as cache warming, use of certain protocols, etc. In some embodiments, an a la carte billing model may be employed where each type of resource managed by the resource manager is billed on a per transaction basis, a feature basis, or a statistics basis. Alternatively, various types of resources may be bundled together to create packages and different service level offerings. With respect to content delivery, a resource consumer may be billed based on the volume or total bytes of traffic served. In such cases, for example, the cost of each transaction may be computed from the product of the price per byte at delivery time and the total bytes delivered for the transaction, which values may be obtained from the log data of the transaction provided by the resource provider at the time of the transaction. In some such cases, the resource manager may add a small surcharge to the price per byte or may bill a flat fee for facilitating the transaction. In other embodiments, the 95th percentile value of a resource consumer may be determined across all resource providers over a billing cycle, e.g., by aggregating the data from the transaction logs provided by the resource providers. In some such cases, the 95th percentile value is multiplied by the fraction of the total traffic over the billing cycle that a particular resource provider delivered to obtain the bandwidth value billable by that resource provider. In such cases, the resource manager may take a small percentage of the amount billed by the resource provider.

Although crowd based content delivery is described in many of the examples provided herein, the resource manager may be similarly employed to facilitate any crowd based computing platform. For example, in some embodiments, the resource manager may facilitate crowd based storage by which content items are replicated for storage across the crowd. In some embodiments, the resource manager may facilitate crowd based computing by which compute modules are distributed across the crowd to perform tasks such as video compression and encoding, encryption cracking, distributed web hosting and/or application execution, etc. In some embodiments, the resource manager may facilitate military purposes such as distributed network defense and offense mechanisms. For example, as a defense mechanism, the crowd may be employed as a distributed DDoS filter to protect from a DDoS attack. Likewise, as an offense mechanism, the crowd may be employed to generate such attacks.

As described, a resource manager may be employed by a publisher to manage client requests for content published by the publisher based on various criteria, preferences, and/or rule sets specified with respect to an account of the publisher with the resource manager. Client requests for at least a subset of content published by the publisher may be directed or redirected to the resource manager, for example, via a CNAME (Canonical Name) record of DNS (Domain Name System). The publisher defines with respect to the account of the publisher with the resource manager a policy for governing the manner in which to redirect incoming content requests to endpoints capable of servicing the requests. In some embodiments, the resource manager may be configured by the publisher to redirect a request based at least in part on the client from which the request originated and/or the content requested. As further described below, in some embodiments, the resource manager is configured by the publisher to redirect certain content request traffic that originates from an internal or private network of the publisher to one or more internal servers of the private publisher network that are capable of servicing such content requests.

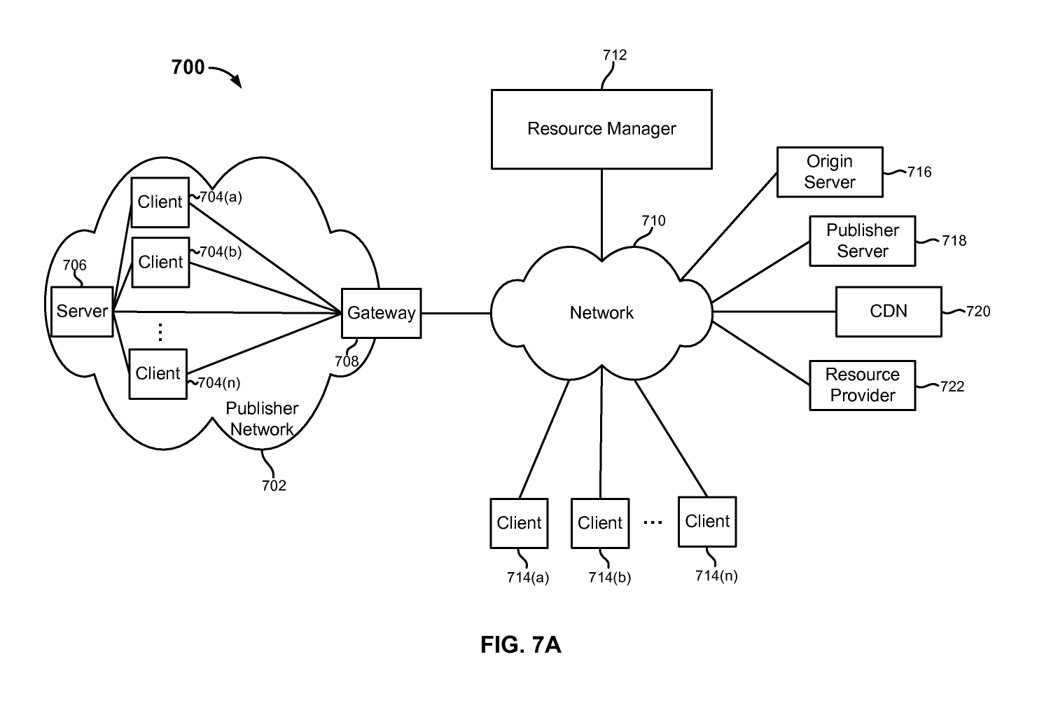

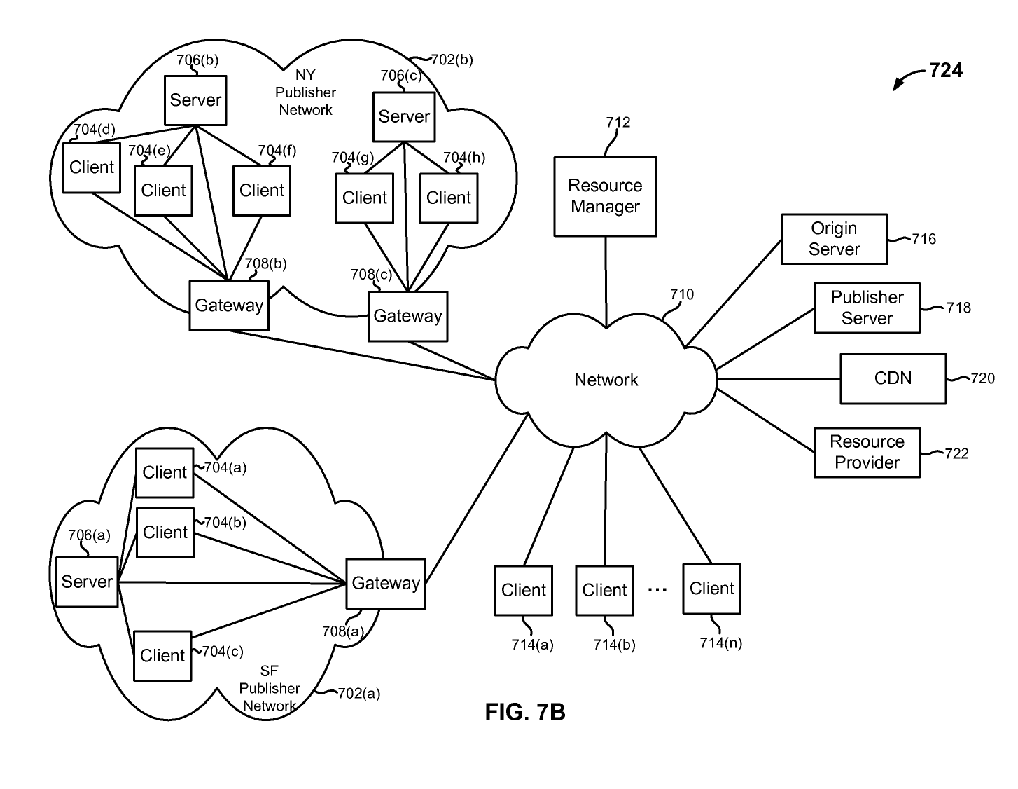

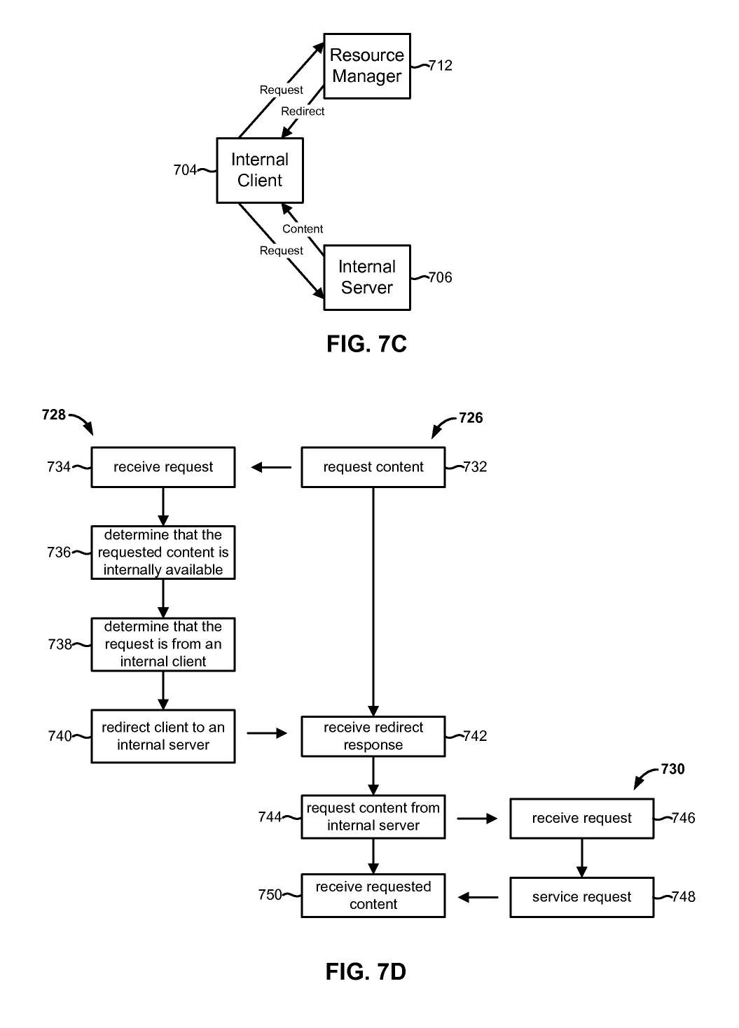

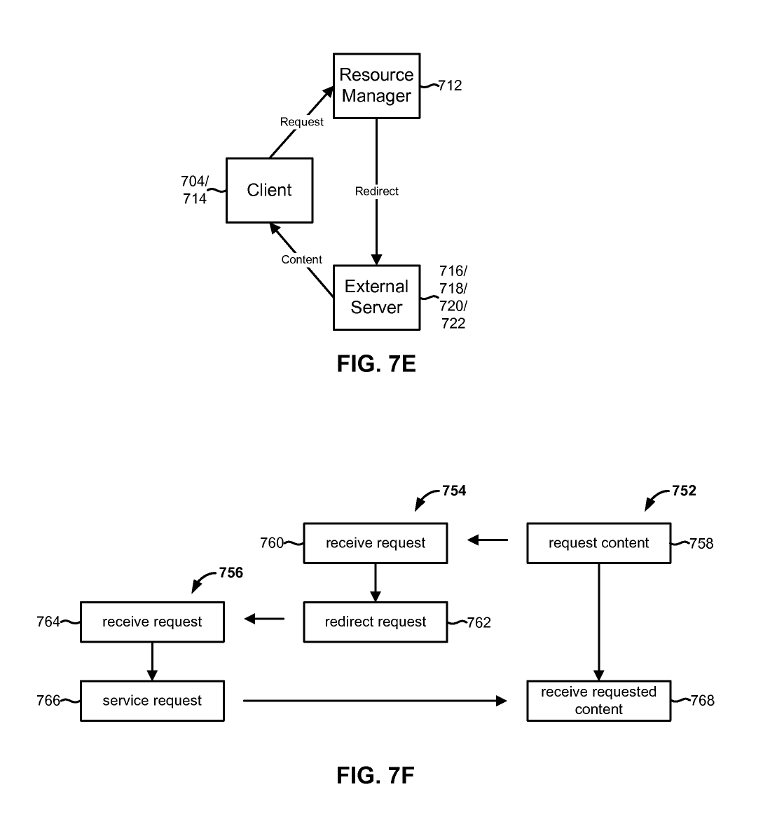

FIG. 7A is a block diagram illustrating a network environment 700 for redirecting clients and/or client requests to an appropriate endpoint in accordance with an embodiment of the present invention. In network environment 700, a content publisher is represented by publisher network 702. A content publisher may comprise any entity or enterprise that either originally publishes content or re-publishes existing content. A published content item may be made available by the publisher to the public, for example, via a URL by which the content item may be accessed and/or obtained. In some embodiments, the publisher comprises a resource consumer, such as resource consumer 104 of FIG. 1. The publisher network comprises a private or internal network of the publisher and includes one or more internal clients and servers. In the given example, publisher network 702 comprises a plurality of internal clients 704 and an internal server 706. Furthermore, the publisher network comprises one or more routers or other gateway devices that connect the private publisher network to a public, external, or other network such as the Internet. In the given example, publisher network 702 comprises gateway device 708 which facilitates communication between publisher network 702 and external network 710. In some embodiments, publisher network 702 comprises a subordinate network of another network, such as a public or other external network such as the Internet 710.

The publisher may subscribe to the services of resource manager 712 for facilitating the servicing of requests for at least a subset of content published by the publisher. In such cases, client requests for such content are directed or redirected to resource manager 712. Resource manager 712 may comprise, for example, resource manager 102 of FIG. 1, 500 of FIG. 5A, and/or 602 of FIGS. 6A-6C. In some embodiments, resource manager 712 is configured to at least in part function as a redirection host. Client requests for content published by the publisher may be received by resource manager 712 from internal clients 704 of the publisher via publisher network 702 and/or from external clients 714 over external network 710. In some embodiments, resource manager 712 is configured by the publisher to redirect an internal client 704 requesting content published by the publisher that is available at an internal server of the publisher to internal server 706 and to redirect requests for the same content from external clients 714 to an external server capable of servicing the request, such as an origin 716 of the publisher, another server 718 of the publisher, a CDN 720 contracted by the publisher, or another resource provider 722 configured to serve content on behalf of the publisher. Resource provider 722 may comprise, for example, resource provider 106 of FIG. 1 and/or 608 of FIGS. 6A-6C.

Redirection of internal clients 704 to internal server 706 may be desirable to avoid congestion at gateway 708, especially when a large number of internal clients 704 simultaneously access or download high-bandwidth content. Such a scenario may arise within an enterprise, for instance, during a live feed or video event that is of interest to the employees of the enterprise, such as a keynote address from an executive of the enterprise. In this case, the enterprise comprises the publisher, and publisher network 702 comprises a private enterprise or corporate network. Content may be published by the enterprise, for example, at origin 716, server 718, and/or contracted CDN 720. In various embodiments, origin 716 may comprise an external node of the enterprise on network 710 where content is published or may be a part of a CDN 720 contracted by the enterprise. In various embodiments, server 718 may be part of an external data center or server farm of the enterprise. In the aforementioned scenario, a large number of users may simultaneously access a live video stream from both private network 702 as well as external network 710. Gateway 708, however, may not have the capacity to support simultaneous delivery of such high-bandwidth content from an external node to a large number of internal users 704 at an acceptable quality. Gateway congestion can be prevented by also storing a copy of the live video stream at one or more internal servers such as internal server 706 that can locally serve internal clients 704. In some cases, an internal copy of the live video stream is downloaded at internal server 706 from an external node at which the video is originally published such as origin 716, server 718, and/or CDN 720. It may not be desirable, however, to rely on internal users to independently obtain the video from an internal rather than an external server. In fact, it may be preferable to publish a single URL for accessing the video stream for all users so that user access of the video stream is seamless regardless of whether the users comprise internal clients 704 within the enterprise intranet 702 or external clients 714 on the Internet 710. This can be achieved by configuring resource manager 712 to receive each client request for the video stream and appropriately redirect the requesting client and/or request to an appropriate endpoint capable of servicing the request.

In some embodiments, the publisher specifies with respect to its account with resource manager 712 information such as the IP addresses of internal clients such as clients 704, the IP addresses of internal servers such as server 706, gateway IP addresses of the publisher network such as of gateway 708, content available and/or a manner in which to identify content available at internal servers such as server 706, etc., as well as rules that govern the behavior of resource manager 712 for redirecting different clients and/or content requests. For example, the publisher may create a rule set that specifies that internal clients 704 requesting publisher content available within publisher network 702 are to be redirected by resource manager 712 to an internal server such as server 706, but requests from external clients 714 for the same content are to be redirected by resource manager 712 to one or more external nodes capable of servicing the requests such as external nodes 716-722. In some embodiments, the publisher may provide resource manager 712 with a list of content items available internally at servers within publisher network 702 so that resource manager 712 can redirect internal clients 704 requesting content from the list to an internal server 706 of publisher network 702. In cases in which different internal servers of publisher network 702 have possibly different sets of content, the publisher may also specify the specific internal servers at which each content item is available. In some embodiments, content available internally within publisher network 702 may be identified by resource manager 712 by prescribed metadata or another identifier associated with a request that indicates that the requested content is available at an internal server of publisher network 702. For example, a URL associated with content published by the publisher may include a prescribed parameter that indicates that the content is also available at an internal server of publisher network 702. In such cases, resource manager 712 may determine that the content is available at an internal server of publisher network 702 by parsing the request URL and determining that the prescribed parameter is a part of the URL.

In response to resource manager 712 receiving a client request for a content item identified as being available internally within publisher network 702, resource manager 712 can determine whether the requesting client comprises an internal client 704 of publisher network 702 or an external client 714 by comparing, for instance, an IP address associated with the request with a list of IP addresses of internal clients 704 and/or gateways 708 of publisher network 702 registered with resource manager 712 by the publisher. In the event that the requesting client is determined to be an internal client 704 of publisher network 702, in some cases, resource manager 712 redirects the client to internal server 706, for example, by providing in response to the client request the IP address of internal server 706. The IP addresses of internal servers such as server 706 are also registered with resource manager 712 by the publisher and may comprise non-routable internal IP addresses such as RFC 1918 or RFC 4193 IP addresses that are not accessible via a public or other external network such as the Internet. Thus, in some such cases, instead of redirecting the client request, request manager 712 instead redirects client 704 by providing to client 704 the private IP address of internal server 706 from which client 704 can obtain the requested content. In other embodiments in which internal server 706 has a routable IP address, resource manager 712 may directly redirect the client request to internal server 706. In the event that the requesting client is determined to be an external client 714, in some cases, resource manager 712 redirects the client request and/or client to an external node such as one of nodes 716-722 capable of servicing the request.

By configuring resource manager 712 to route traffic for certain publisher content that originates from an internal publisher network 702 back to an internal server 706 of publisher network 702, gateway 708 congestion can be prevented, for example, when a large number of internal clients 704 simultaneously access high-bandwidth content. Requests from internal clients 704 to resource manager 712 and responses to internal clients 704 from resource manager 712 comprise very low-bandwidth communications that do not compromise gateway 708 performance even when such communications occur in parallel with respect to a large number of internal clients 704. In some embodiments, the publisher may configure resource manager 712 to redirect content requests from internal clients 704 to internal servers 706 only for a prescribed set of publisher content, such as high-bandwidth content that is expected to be simultaneously accessed by a large number of internal users. In such cases, requests for other content from internal clients 704 are serviced by appropriate servers on external network 710. For example, requests received from internal clients 704 for content that has not been specified by the publisher as being available internally within publisher network 702 and/or requests received from internal clients 704 that do not include a prescribed identifier that specifies that the requested content is available internally within publisher network 702 may be redirected by resource manager 712 to appropriate servers on external network 710 that are capable of servicing the requests.

Although a single internal server 706 is depicted in FIG. 7A, in other embodiments, publisher network 702 may comprise a plurality of internal servers such as server 706. In some embodiments, publisher network 702 comprises an internal CDN comprising a plurality of internal servers that store and serve content. In such cases, resource manager 712 may be employed to at least in part manage and/or load balance the plurality of internal servers of the publisher by appropriately redirecting internal clients 704 to internal servers such as server 706 capable of servicing the requests. In some cases, resource manager 712 is configured to redirect an internal client 704 to a geographically nearest internal server 706 that has the capability and capacity to service the client request. In some embodiments, publisher network 702 spans a plurality of geographical locations, i.e., comprises a plurality of private networks distributed across a plurality of geographical locations. In some cases, in addition to specifying the IP addresses of internal clients 704, internal servers 706, and/or gateways 708 with respect to its account with resource manager 712, the publisher may also specify the geographical locations of such devices. Such location information may be employed by resource manager 712 to maintain a geographical database that maps the IP addresses of various devices of publisher network 702 to locations so that requests from internal clients 704 may be redirected, for example, to a geographically closest available internal server 706 capable of servicing the request. In various embodiments, internal servers such as server 706 of publisher network 702 may each store the same or different sets of content. In the cases in which different sets of content are stored at different internal servers, the publisher may also specify with respect to its resource manager account the content available at each internal server so that resource manager 712 can direct internal clients 704 to an appropriate internal server 706.

FIG. 7B is a block diagram illustrating a network environment 724 in which the publisher network comprises private networks in a plurality of geographical locations in accordance with an embodiment of the present invention. In the given example, the publisher network comprises private networks 702(a) and 702(b) in San Francisco and New York, respectively. The San Francisco publisher network 702(a) comprises internal clients 704(a)-(c), internal server 706(a), and gateway 708(a). The New York publisher network 702(b) comprises internal clients 704(d)-(h), internal servers 706(b)-(c), and gateways 708(b)-(c). In New York network 702(b), for instance, internal clients 704(d)-(h), internal server 706(b), and gateway 708(b) may be located in a first building while internal clients 704(g)-(h), internal sever 706(c), and gateway 708(c) may be located in a second building. In the given example, the two portions 702(a) and 702(b) of the publisher network are connected via an external network 710 such as the Internet, e.g., via a virtual private network (VPN). In some embodiments, the publisher configures resource manager 712 to redirect internal clients 704 requesting certain content available within the internal publisher network 702 to geographically nearest internal servers 706 that are capable of servicing the requests. For example, resource manager 712 may redirect internal clients 704 to internal servers 706 based at least in part on a geographical database comprising location information provided by the publisher. Resource manager 712 may determine the geographical location of an internal client 704, for instance, by mapping a source IP address provided with the client request to a location using the geographical database. In some cases, a private (e.g., RFC 1918 or RFC 4193) IP address of a client 704 may be provided with a client request, e.g., via a cookie associated with the request or by an associated gateway device 708 via which the client request is forwarded to resource manager 712.

In the example of FIG. 7B, internal clients 704(a)-(c) requesting content available at any of internal servers 706(a)-(c) are redirected by resource manager 712 to geographically nearest internal server 706(a) in San Francisco; internal clients 704(d)-(f) requesting content available at any of internal servers 706(a)-(c) are redirected by resource manager 712 to geographically nearest internal server 706(b) in New York; and internal clients 704(g)-(h) requesting content available at any of internal servers 706(a)-(c) are redirected by resource manager 712 to geographically nearest internal server 706(c) in New York. In some cases, however, an internal client 704 may be redirected by resource manager 712 to an internal server 706 that is not the geographically nearest internal server, for example, if the geographically nearest internal server does not have the requested content or otherwise does not have the capacity or capability of servicing the client request, e.g., due to operating at maximum capacity, being offline for maintenance, etc. For example, internal clients 704(d)-(f) may be redirected by resource manager 712 to internal server 706(c) instead of internal server 706(b) if a threshold number of other internal clients are already being serviced by internal server 706(b); internal clients 704(g)-(h) may be redirected by resource manager 712 to internal server 706(b) instead of internal server 706(c) while internal server 706(c) is down for maintenance; and internal clients 704(a)-(c) may be redirected to internal servers 706(b)-(c) and/or an external server 716-722 instead of internal server 706(a) if internal server 706(a) does not have the requested content.

As described, resource manager 712 may be employed by the publisher to at least in part manage its internal network 702 and to route internal clients 704 requesting certain content available within publisher network 702 to an appropriate internal server 706. Furthermore, resource manager 712 may be employed by the publisher to manage one or more of its origin or other external servers, data centers, and/or server farms that are accessible via external network 710. For example, resource manager 712 may be configured to manage origin server 604 in FIGS. 6A-6C as well as origin server 716 and/or publisher server 718 in FIGS. 7A -7B. Content requests from external clients 714 are redirected by resource manager 712 to one of external nodes 716-722. Content requests from internal clients 704 may also be redirected by resource manager 712 to one of external nodes 716-722, e.g., if the requested content is not internally available within publisher network 702 at an internal server 706 or if internal servers 706 are already operating at maximum capacity or are otherwise unavailable to service the requests. In some embodiments, resource manager 712 may be configured to redirect requests for publisher content to origin server 716 and/or publisher server 718 as long as they have the capability and capacity to service the requests and otherwise redirect requests to a CDN 720 and/or another resource provider 722 contracted by the publisher. In some cases, to minimize or at least reduce latency, requests are redirected to servers 716 and/or 718 while the servers have the capability and capacity to service the requests if the requesting clients are geographically located close to servers 716 and/or 718 but are otherwise redirected to a contracted CDN 720 and/or another resource provider 722. For example, if servers 716 and/or 718 are located in California, west coast traffic may be redirected to these servers as long as the servers are operating below maximum capacity while traffic from all other locations is redirected to CDN 720 and/or resource provider 722. In some embodiments, resource manager 712 monitors various performance metrics of external nodes 716-722, such as, for example, disk performance, CPU performance, bandwidth utilization, etc. Resource manager 712 may be further configured to base redirection decisions on current performance levels of servers 716 and/or 718 as well as various thresholds specified by the publisher. For example, the publisher may specify with respect to its account with resource manager 712 rules for load balancing servers 716 and/or 718 as well as capacity thresholds for each server so that server usage for servicing client requests may be maximized. Setting server capacity thresholds, for instance, prevents performance degradations and outages due to being overburdened with excessive traffic and ensures that at least a prescribed quality of service is maintained. In some such cases, traffic beyond the capacity thresholds of servers 716 and/or 718 is redirected by resource manager 712 to a CDN 720 and/or another resource provider 722 contracted by the publisher. Although an origin server 716 and publisher server 718 are depicted in FIGS. 7A-7B, the publisher may have any number and combination of origin or other external servers, data centers, and/or server farms accessible via external network 710 and distributed across one or more geographical regions.

FIG. 7C is a block diagram illustrating communications involved in servicing a content request in accordance with an embodiment of the present invention, and FIG. 7D comprises flow charts illustrating corresponding processes. In the given example, processes 726, 728, and 730 of FIG. 7D are employed by internal client 704, resource manager 712, and internal server 706 of FIG. 7C, respectively. As described with respect to FIGS. 7A-7B, internal client 704 and internal server 706 are part of a private publisher network 702 while resource manager 712 is accessible via an external network 710. Thus, communications between internal client 704 and resource manager 712 occur via external network 710 while communications between internal client 704 and internal server 706 occur within internal publisher network 702. Requests for at least a subset of content published by the publisher may be directed or redirected to resource manager 712 so that resource manager 712 can manage traffic for the publisher content and select appropriate endpoints for servicing the requests based on, for example, a policy specified by the publisher. Process 726 starts at 732 when content is requested by internal client 704. The content request from internal client 704 is received by resource manager 712 at 734. In some embodiments, the content request is generated in response to a user of internal client 704 selecting or otherwise accessing a URL associated with the requested content. At 736, resource manager 712 determines that the requested content is available at an internal server within the publisher network, for example, based on a prescribed identifier or parameter associated with the content request and/or based on a list of content items specified by the publisher as being available within the publisher network. At 738, resource manager 712 determines that the content request is received from an internal client 704 of the publisher network, for example, by comparing a source IP address associated with the request with a list of IP address of internal clients and/or gateway devices of the publisher network provided to resource manager 712 by the publisher. Resource manager 712 responds to the content request by redirecting internal client 704 to an internal server 706 capable of servicing the request at 740. In some embodiments, 740 comprises selecting one of a plurality of internal servers based at least in part on one or more criteria. For example, in some cases, a geographically nearest internal server 706 capable of servicing the request may be selected at 740. In some cases, an internal server 706 may be selected based on load balancing the plurality of internal servers. Any appropriate redirection mechanism may be employed at 740, such as an HTTP 3xx redirect. In some embodiments, the redirect response from resource manager 712 includes an IP address of internal server 706. In some cases, the IP address of internal server 706 comprises a private, non-routable IP address. The redirect response of 740 from resource manager 712 is received by internal client 704 at 742. Internal client 704 subsequently requests the content at 744 from the internal server 706 indicated by the redirect response, i.e., from the internal sever 706 having the IP address provided with the redirect response. At 746, the content request is received by internal server 706. The content request is serviced by internal server 706 at 748. The requested content provided by internal server 706 is received by internal client 704 at 750.

FIG. 7E is a block diagram illustrating communications involved in servicing a content request in accordance with an embodiment of the present invention, and FIG. 7F comprises flow charts illustrating corresponding processes. FIGS. 7E-7F may be applicable, for instance, for servicing a content request from an internal client 704 when no internal server 706 is able to service the request and/or for servicing a content request from an external client 714. In the given example, processes 752, 754, and 756 of FIG. 7F may be employed by client 704/714, resource manager 712, and external server 716/718/720/722 of FIG. 7E, respectively. As described with respect to FIGS. 7A-7B, a publisher may be associated with one or more external servers 716-722 that are accessible via external network 710 and capable of servicing requests for content published by the publisher. Requests for at least a subset of content published by the publisher may be directed or redirected to resource manager 712 so that resource manager 712 can manage traffic for the publisher content and select appropriate endpoints for servicing the requests based on, for example, a policy specified by the publisher. Process 752 starts at 758 when content is requested by client 704/714. The content request from client 704/714 is received by resource manager 712 at 760. In some embodiments, the content request is generated in response to a user of client 704/714 selecting or otherwise accessing a URL associated with the requested content. At 762, resource manager 712 redirects the request to an external server 716/718/720/722 capable of servicing the request, for example, because the requested content is not internally available within publisher network 702, because no internal server 706 is available to service the request, because the request is received from an external client 714, etc. In some embodiments, 762 comprises selecting one of a plurality of external servers 716-722 based at least in part on one or more criteria. For example, in some cases, origin server 716 and/or another publisher server 718 may be selected at 762 as long as the servers have the capacity to service the request in order to minimize publisher cost in servicing the request. In some such cases, CDN 720 and/or another resource provider 722 may be selected at 762 only if origin server 716 and/or publisher server 718 are already operating at maximum capacity or are otherwise unavailable to service the request. In some embodiments, a geographically nearest external server 716/718/720/722 capable of servicing the request may be selected at 762. In some embodiments, the selection of 762 is based on load balancing at least a subset of the plurality of external servers 716-722 associated with the publisher. Any appropriate redirection mechanism may be employed at 762. The redirected request is received by external server 716/718/720/722 at 764. The content request is serviced by external server 716/718/720/722 at 766. The requested content provided by external server 716/718/720/722 is received by client 704/714 at 768.

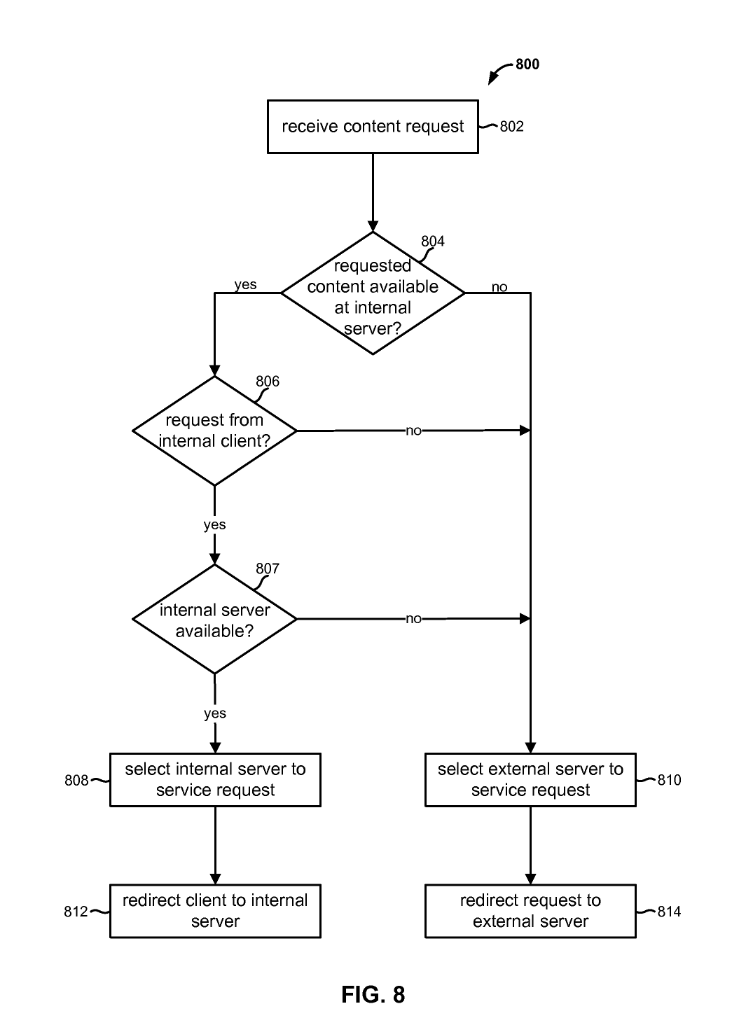

FIG. 8 illustrates a process for selecting an appropriate endpoint for servicing a client request in accordance with an embodiment of the present invention. In some embodiments, process 800 is employed by resource manager 102 of FIG. 1, 500 of FIG. 5A, 602 of FIGS. 6A-6C, and/or 712 of FIGS. 7A-7F. Process 800 starts at 802 at which a content request is received from a client. At 804, it is determined whether the requested content is available at an internal server within the publisher network. The determination of 804 may be based on, for example, the presence or absence of a prescribed identifier or parameter with the content request and/or a list of content items specified by the publisher as being available within the publisher network. If it is determined at 804 that the requested content is available at an internal server within the publisher network, at 806 it is determined whether the request of 802 is received from an internal client of the publisher network. The determination of 806 may be based on, for example, a comparison of a source IP address associated with the request and a list of internal client and/or gateway IP addresses provided by the publisher. If it is determined at 806 that the request is received from an internal client, it is determined at 807 whether any internal servers are available to service the request, e.g., within the publisher network. If it is determined at 807 that one or more internal servers are available to service the request, an internal server capable of servicing the request is selected at 808. If it is determined at 804 that the requested content is not available at an internal server of the publisher network, if it is determined at 806 that the request is not received from an internal client of the publisher network, or if it is determined at 807 that no internal servers are available to service the request, an external server capable of servicing the request is selected at 810. The internal server of 808 or the external server of 810 may be selected based on various criteria, such as geographical proximity, server load, cache locality of the requested content, etc. At 812, the client from which the request is received at 802 is redirected to the internal server selected at 808. In some embodiments, the redirection of 812 comprises providing to the client an IP address of the internal server selected at 808. At 814, the request received at 802 and/or the requesting client is redirected to the external server selected at 810. Any appropriate redirection mechanisms may be employed at 812 and 814. Process 800 subsequently ends.

Resource manager 712 provides a unified, web-based platform by which a publisher may implement a personalized content delivery strategy for content published by the publisher. As described, resource manager 712 may be employed to manage the internal network of the publisher as well as one or more external nodes affiliated with the publisher. In some embodiments, resource manager 712 provides a web-based user interface via which the publisher may easily specify and dynamically change information as well as various preferences and/or rules for governing the redirection of requests for publisher content. Redirecting clients and/or content requests based on various criteria such as the requested content, requesting client, geography, server load, cache locality, etc., has been described with respect to some of the given examples. However, the techniques described herein may be similarly employed with respect to any other criteria that may be employed to discriminate between clients and/or content requests and/or to select endpoints for servicing requests. For example, a security policy may at least in part be implemented by the publisher with respect to its resource manager account by specifying permissions for various content items and/or rules for restricting access to certain content items to clients included in corresponding access lists. Preferences and/or rules specified by the publisher as well as other information specified by the publisher are employed by resource manager 712 to dynamically implement a content delivery policy on behalf of the publisher.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for redirecting a content request, comprising:
receiving a content request at a redirect host that communicates via a public network;
determining, by the redirect host, that the content request is received from an internal client of a private network;
determining, by the redirect host, that an internal server within the private network is available to service the request; and
redirecting, by the redirect host, the client or request to the internal server of the private network.

2. The method of claim 1, wherein the private network is a subordinate network of the public network and communicates with the public network in a limited fashion.

3. The method of claim 1, wherein the public network comprises the Internet.

4. The method of claim 1, wherein the redirect host is configured to implement a content delivery policy on behalf of a publisher of the requested content.

5. The method of claim 1, wherein redirecting the client to the internal server comprises providing an Internet Protocol (IP) address of the internal server to the client.

6. The method of claim 5, wherein the IP address of the internal server comprises a private IP address.

7. The method of claim 1, wherein the internal client and the internal server are both located in geographical proximity to one another.

8. The method of claim 1, wherein the internal server is capable of servicing the content request via communications within the private network.

9. A system for redirecting a content request, comprising:
a processor configured to:
receive a content request, wherein the processor communicates via a public network;
determine that the content request is received from an internal client of a private network;
determine that an internal server within the private network is available to service the request; and
redirect the client or request to the internal server of the private network; and
a memory coupled to the processor and configured to provide the processor with instructions.

10. The system of claim 9, wherein the private network is a subordinate network of the public network and communicates with the public network in a limited fashion.

11. The system of claim 9, wherein the public network comprises the Internet.

12. The system of claim 9, wherein the redirect host is configured to implement a content delivery policy on behalf of a publisher of the requested content.

13. The system of claim 9, wherein redirecting the client to the internal server comprises providing an Internet Protocol (IP) address of the internal server to the client.

14. The system of claim 13, wherein the IP address of the internal server comprises a private IP address.

15. The system of claim 9, wherein the internal client and the internal server are both located in geographical proximity to one another.

16. The system of claim 9, wherein the internal server is capable of servicing the content request via communications within the private network.

17. A computer program product for redirecting a content request, the computer program product being embodied in a non-transitory computer readable storage medium and comprising computer instructions for:
receiving a content request, wherein the computer program product communicates via a public network;
determining that the content request is received from an internal client of a private network;
determining that an internal server within the private network is available to service the request; and
redirecting the client or request to the internal server of the private network.
